(19) United States
(12) Patent Application Publication
(10) Pub. No.: US 2014/0244276 A1
(43) Pub. Date: Aug. 28, 2014

(54) Systems and Methods for Classifying Healthcare Management Operation

(71) Applicant: MCKESSON FINANCIAL HOLDINGS, Hamilton (BM)

(72) Inventors: David Dyke, Jenks, OK (US); James Greene, Marietta, GA (US)

(73) Assignee: McKesson Financial Holdings, Hamilton (BM)

(21) Appl. No.: 13/781,149

(22) Filed: Feb. 28, 2013

(51) Int. Cl. G06Q 10/06; G06Q 50/22

(52) U.S. Cl. CPC G06Q 10/0639; G06Q 50/22
USPC 705/2

(57) ABSTRACT

Embodiments include systems and methods for ranking the operations or job functions performed by a healthcare provider. The system may determine the job functions that may be analyzed for the ranking process. The system may analyze how the healthcare provider implements the job functions and determine a ranking of the healthcare provider based, at least in part, on the job function analysis.

### FIELD OF THE DISCLOSURE

Embodiments of the disclosure relate generally to healthcare information, and more particularly, to systems and methods for classifying healthcare operations related to patient intake, healthcare cost estimates, and payments for healthcare services.

### BACKGROUND

Healthcare providers and/or systems facilitate the intake and billing for healthcare services using a variety of manual and computer-aided methods. However, the complexity and diversity of these methods make it difficult to compare the methods or operations of the healthcare providers or systems. Accordingly, healthcare providers may desire a system that may classify their operations in a way that indicates the level of sophistication and may indicate areas for improvement.

### SUMMARY

This disclosure describes systems and methods for determining performance criteria for healthcare provider systems and methods that may enable the classification of a level of sophistication for the healthcare provider systems and methods.

A healthcare organization may have developed systems and methods for managing patient intake, billing, and collections. The systems and methods may have different levels of maturity or sophistication based, at least in part, on the performance criteria for various aspects of the systems and methods. The performance criteria may be ranked based on their level of sophistication based, at least in part, on their level of documentation, automation, and verification of procedures used for conducting their business.

The performance criteria may cover various aspects of the patient intake, billing, and collections. The performance criteria may include, but is not limited to: process documentation, staffing requirements to perform the processes, frequency of use of the processes, billing modeling capability, billing estimate capability, scope of usage of process documentation through the business, collection capabilities, process tracking and compliance, and/or accuracy of billing estimates compared to actual costs owed by the patient.

The performance criteria may be ranked based on the level or degree of sophistication of implementation by the healthcare provider. Broadly, the level of sophistication may be based on whether the processes and procedures are repeatable, defined, managed, and/or optimized to enable customer satisfaction and operational efficiency of the healthcare provider. The ranking may be based on an amount or degree to which the processes and procedures are repeatable, defined, managed, and/or optimized. The performance criteria may reflect job functions performed by the healthcare provider related to documentation, staffing, and/or other operational aspects.

Following the ranking of the performance criteria, the performance criteria rankings may be categorized into a performance scale that may include different levels that reflect the maturity or sophistication of the healthcare provider operations. The performance scale ranking may be reflective of an overall ranking of the healthcare provider, rather than the individual rankings of the performance criteria. The healthcare provider may be assigned a position on the performance scale based, at least in part, on amount performance criteria rankings assigned to a ranking. In one embodiment, the performance scale may be analogous to the performance criteria ranking in that performance criteria with an optimized ranking may be assigned to the optimized level on the performance scale. The overall ranking on the performance scale may be based on how many performance criteria have been assigned to each of the performance scale levels. For example, in one embodiment, the overall ranking of the healthcare provider may be based on the performance scale level that has the most performance criteria assigned to that performance scale level.

Broadly, the performance scale categories may range from initial, repeatable, defined, managed, and optimized. The initial category may indicate the business processes are undocumented or unregulated. The repeatable category may indicate the business processes may be documented in varying degrees that may not be consistent across the organization. The managed category may indicate the business processes may be documented and monitored across a broader spectrum of the organization. The optimized category may indicate the business processes may be documented, monitored across most of the organization and that the business processes may be improved based on performance monitoring or feedback.

Other systems, methods, apparatuses, features, and aspects according to various embodiments of the disclosure will become apparent with respect to the remainder of this document.

### BRIEF DESCRIPTION OF THE DRAWINGS

The features within the drawings are numerically notated to be cross referenced with the written description. Generally, the first numeral reflects the drawing number where the feature was first introduced, and the remaining numerals are intended to distinguish the feature from the other notated features within that drawing. However, if a feature is used across several drawings, the number used to identify the feature in the drawing where the feature first appeared will be used. Reference will now be made to the accompanying drawings, which are not necessarily drawn to scale and wherein:

FIG. 1 illustrates an example system for assessing business processes for a billing/payment system for a healthcare provider according to an exemplary embodiment of the disclosure.

FIG. 2 illustrates a schematic table for an embodiment for ranking job functions or performance criteria for implementing a billing/payment system for a healthcare provider according to an exemplary embodiment of the disclosure.

FIG. 3 illustrates one embodiment of a performance scale of the healthcare provider based, at least in part, on the ranking of the performance criteria for a billing/payment system according to an exemplary embodiment of the disclosure.

FIG. 4 illustrates a flow diagram of a method for assessing the billing/payment system of a healthcare provider according to an exemplary embodiment of the disclosure.

FIG. 5 illustrates a flow diagram of another method for assessing the billing/payment system of a healthcare provider according to an exemplary embodiment of the disclosure.

### DETAILED DESCRIPTION

Embodiments of the disclosure will be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those of ordinary skill in the art.

Embodiments of the disclosure may describe systems, methods, and apparatuses for assessing the business operations of a healthcare provider. In one embodiment, the healthcare provider may determine a variety of performance criteria may be used to track or assess how the healthcare provider implements their business with regard to patient intake, patient billing, and/or collections for services provided to the patient. This and other embodiments are described more fully below with reference to the accompanying figures, in which embodiments of the disclosure are shown.

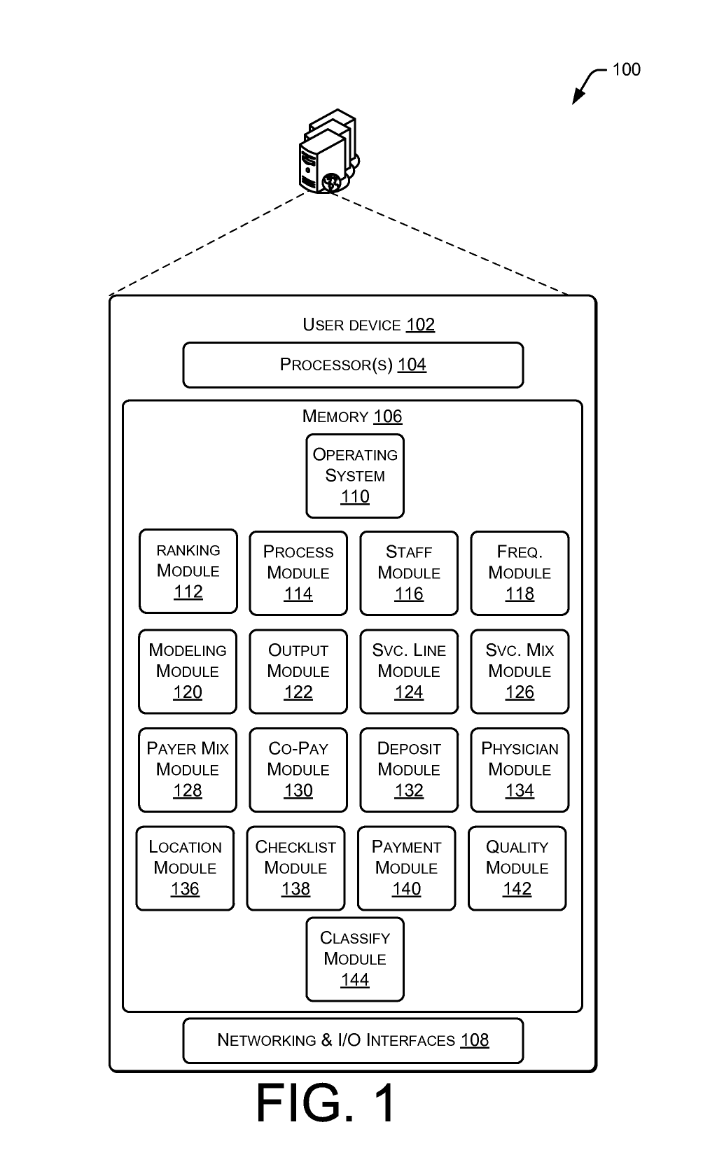

FIG. 1 illustrates an example system 100 that may assess the billing/payment system for a healthcare provider (not shown) by ranking a variety of performance criteria for one or more aspects of the healthcare provider's operations which may include, but is not limited to, patient intake, patient billing, and/or collecting payments from patients. The system 100 may include a user device 102 that receives information related to the healthcare provider's billing/payment system over a network (not shown) or by the information being collated and entered into the user device 102 by a user using the Input/Output interface of the user device 102. In one embodiment, the healthcare provider may be a hospital, a clinic, a health maintenance organization, a surgery center, a physical/occupational therapy center, a nursing home, or any combination thereof.

The user device 102 may determine the performance criteria that may be used to assess the billing/payment system of the healthcare provider. Broadly, the performance criteria may cover individual operations performed at or by the healthcare provider in the course of providing care or services to patients. The performance criteria may be ranked based, at least in part, on how the healthcare provider executes the individual operations. The ranking may be based broadly on the degree of sophistication of the execution. For example, the ranking may vary based on whether the operations may be repeatable in a way that produces similar results between several instances of the operation. The ranking of certain performance criteria may also vary based on whether operations are defined or how well the operations may be documented. Performance criteria may also be ranked on the level of management that controls or monitors the healthcare provider operations. In another instance, the performance criteria may also be ranked based, at least in part, on the degree of optimization of the operations that may be implemented by the healthcare provider. The user device 102 may also classify the healthcare provider's operations on a performance scale based, at least in part, on the rankings of the performance criteria. The performance scale may include different levels that may segregate or bin the performance criteria based on their respective rankings. In one instance, the level of the performance scale with the most performance criteria may reflect the grade or overall ranking that may be assigned to the healthcare provider.

In one embodiment, the user device 102 may include one or more computer processors 104, memory 106, input/output (I/O) and network interfaces 108.

The computer processor 104 may execute computer-readable instructions stored in memory 106. The one or more computer processors 104 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 102 may also include a chipset (not shown) for controlling communications between the one or more processors 104 and one or more of the other components of the user device 102. In certain embodiments, the user device 102 may be based on an Intel® Architecture system and the processor(s) 104 and chipset may be from a family of Intel® processors and chipsets, such as the Intel® Atom® processor family. The one or more processors 104 may also include one or more application-specific integrated circuits (ASICs) or application-specific standard products (ASSPs) for handling specific data processing functions or tasks.

The user device 102 may also include an I/O and network interface 108 which may include a variety of elements that enable the display of content and/or receiving user inputs. For instance, the I/O interface may include a display, a keyboard, a mouse, a touch screen display, a voice recognition interface, a motion recognition interface, and/or a touchpad.

A network interface may include a modem or any other communication device that enables the user device 102 to send and receive information over a network (not shown).

The memory 106 may store a variety of modules to operate the device and provide various aspects of functionality that are common to computing devices. For example, an operating system 110 may provide file management capability, interpret user inputs, and manage the resources on the consumer computer 102. The operating system 110 may provide the processor 104 with a variety of instruction sets to perform mathematical or logic operations that enable the functionality of the display and other sensory elements that present content to or receive content from the user. The memory 106 may also store one or more data files that perform a variety of tasks or operations on the user device 102. The memory 106 may include one or more volatile and/or non-volatile memory devices including, but not limited to: random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The user device 102 may include several modules to implement guideline generation, verification of treatment plans, and verification of treatment plan implementation. The modules may include, but are not limited to: a ranking module 112, a process module 114, a staff module 116, a frequency module 118, a modeling module 120, an output module 122, a service line module 124, a service mix module 126, a payer mix module 128, a co-pay module 130, a deposit module 132, a physician module 134, a location module 136, a checklist module 138, a payment module 140, a quality module 142, and/or a classifying module 144.

The ranking module 112 may rank job functions or performance criteria that the healthcare provider may use in their billing/payment system. In one embodiment, the ranking may be based on where the performance criteria or job function falls on a ranking scale that may indicate the level of maturity or sophistication. In one instance, the ranking scale may include several levels that segregate a performance criterion based on a degree of maturity or sophistication. In one exemplary embodiment, the ranking scale may include five levels from lowest to highest: initial, repeatable, defined, managed, and optimized.

The initial ranking may indicate the lowest level of sophistication for performance criteria. Broadly, the initial ranking may indicate the healthcare provider may not have adopted a strategic approach for implementing or managing the job function(s) for the performance criterion. This may include job functions that are still in the pilot phase and the healthcare provider may not have documented procedures, regulations, or guidelines that have been approved or authorized by the healthcare provider. The initial ranking may also be based on the type of staff member who may perform the job function. Generally, the initial ranking may apply when the performance criteria are a staff member or a select group of staff members that are capable of performing the job function. For instance, this may include a domain expert who may be singularly capable of performing the job function based on their experience or expertise that may not be found in other staff members. The domain expert may develop and implement their own procedures or techniques to execute a job function. The domain expert status may also be applied to an individual that performs job functions that other similarly situated employees may not perform. For example, when a staff member is tasked to perform a job function that their peers are not capable of performing or authorized to perform, that staff member may be classified as a domain expert.

The initial ranking may also apply to the narrowness of the performance criteria or job function. For example, the initial ranking may apply to job functions that are executed in an ad-hoc manner or a special case basis that may indicate a lack of procedures or guidelines to use when executing the job function or a task. The narrowness may also apply to job functions that are limited to a specific work area and may not be applied to the broader organization. For example, the day shift may execute the job function differently than the night shift or one department may execute a similar or same job function in a different way than other departments of the healthcare provider. In another example, the departments may use different procedures to collect the same information. The initial ranking may also apply when the job function is limited by the means to implement the job function. This may be the result of limited options based on training, equipment, or guidelines that limit the scope or the ability to complete a job function. For example, the ability to collect payments using a single or limited amount of payment or insurance methods.

The initial ranking may also apply to job functions that the healthcare organization may not perform. For example, when a performance criterion is not accounted for by the healthcare provider or not performed by the healthcare provider, the performance criterion may be assigned an initial ranking.

The repeatable ranking may be the level above the initial ranking and may be assigned to performance criteria that may have more structure and organization than the initial ranking. Broadly, the repeatable ranking may indicate that the job function may be performed in a more repeatable manner than an initial ranked performance criteria or job function.

In one instance, the job function may be performed in a more repeatable manner when guidelines or procedures may be documented. The documentation may be in written or electronic form and may be informally distributed to the proper employees. Management approval of the documentation may not be required to achieve the repeatable ranking.

In terms of staffing, the repeatable ranking may be assigned to performance criteria in which the job function may be performed by supervisor level staff member. In contrast to the domain expert, the ability to perform the job function may apply to a senior staff member that has had professional training or certification. For example, a financial counselor who performs patient intake for the insurance information may be one example of a repeatable ranking for the patient intake job function. In other instances, a registrar may handle other portions of the patient intake, but may not handle the insurance or payment information that may be done by the financial counselor.

In terms of cost estimates, the repeatable ranking may include the use of historical claims to generate a patient's cost estimate. This may include, but is not limited to, a fee schedule that may include non-itemized costs for a select or limited group of services provided by the healthcare provider may also be assigned a repeatable ranking. In this way, a standardized estimate form may also rank the cost estimate job function at the repeatable level. However, the standardized estimate may not account for different types of treatment procedures that may be available or account for differences in how doctors or medical professionals may implement those procedures. For example, this may include using different treatment techniques or equipment that doctors may elect to use that other doctors may not use to treat patients. This ranking level may also be applied when the cost estimates are used for a portion of the services provided by the health care provider. For example, certain practice groups may generate cost estimates but others may not be able to generate cost estimates. A disparate application of the cost estimates across the departments of the healthcare provider may be an indication of a repeatable ranking for a cost estimate job function.

In terms of payment job functions, the repeatable ranking may also apply when payment for the patient services may be limited to a select group of services offered by the healthcare provider. For example, when different departments have different guidelines for collecting insurance co-payments the payment job function may receive a repeatable ranking.

The defined ranking may be the level above the repeatable ranking and may be assigned to performance criteria that may have greater structure and organization than the repeatable ranking. Broadly, the defined ranking may indicate that the job function may be performed in a more defined manner than a repeatable ranked job function. The defined ranking may include, but is not limited to, broader and/or more detailed documentation for a job function than may be found or ranked in the initial or repeatable ranking levels. In another instance, the defined ranking may also be associated with or include the introduction of semi-automated processes to collect information or to automate calculations or processing of the collected information. For example, in one instance, the documentation may be interfaced using semi-automated systems such computers that may be referenced or printed out by staff members. The collected information may be entered or scanned into electronic form in a manual or semi-automated manner. The semi-automated manner may include information that is electronically read from an identification, insurance, and/or payment card or device. The documentation and/or semi-automated functions may be used in a majority of instances in which the job function is covered by documentation and/or semi-automated capabilities.

In terms of staffing, the defined ranking may be assigned to performance criteria in which the job function may be performed by a senior staff member that may or may not have a defined management role or to more experienced staff members. In this instance, the defined ranking may apply to staff members who have received on the job training. Those staff members may not have received professional training to implement the job function. Also, the staff member may not have been certified by a third party to qualify for authorization to execute a defined ranking job function.

In terms of cost estimate, the defined ranking may include a charge history for a particular good or service of the healthcare provider. The charge history may reflect what the healthcare provider may have charged for a similar good or service that may have been previously billed to the patient or another patient. In addition to charge history, the cost estimate may also include payer contract information that may indicate which portion of the cost estimate is the responsibility of the patient and which portion of the cost is the responsibility of a third party payer. In this way, the cost estimate may be a personalized estimate for the patient that may include the third party payer contract payment that may reduce the amount owed by the patient. Since patients may have different third party payer arrangements, the cost estimate may be considered personalized to that patient. This is in contrast to cost estimates that may include standardized fees for a particular service that may be given or billed to any patient that may receive the particular service.

In this defined ranking embodiment, the cost estimate may be provided for a majority of outpatient and inpatient services. In contrast to the repeatable ranking, the defined ranking for cost estimates may indicate that cost estimates may be provided for a larger amount of services than amount of services for the repeatable ranking of cost estimates. In the defined ranking embodiment, the larger number of services may include less than a majority of services offered by the healthcare provider or a department within the healthcare provider system.

In terms of payment job functions, the defined ranking may also apply when payment for services may also be limited to a select group of payment options that may include payment options that may include for government insurance (e.g., Medicare) or contracted private insurance. In this instance, the defined ranking may apply when the payment system may not be open to all payers. For example, the exclusion of certain payers may mean that they are unable to use the semi-automated or automated payment features of the payment system.

In another instance, the defined ranking may also apply when co-payment or payment collection is enabled to occur prior to a patient receiving physician services. For example, in one specific embodiment, this may apply to instances in which the payment system enables a patient to make a payment before receiving emergency department services or urgent care service. These types of services may refer to ambulatory care or outpatient care in which the patient may be registered and discharged within one day.

The defined ranking embodiment for payment job functions may also include estimation/payment reconciliation or quality checks. In this instance, a random selection of cost estimates and payment functions may be reviewed to verify compliance with documented procedures.

The managed ranking may be the level above the defined ranking and may be assigned to performance criteria that may have greater structure and organization than the managed ranking. Broadly, the managed ranking may indicate that the job function may be performed in a way that may include more management oversight than the job functions ranked at the defined level. The oversight, in one instance, may include an attempt to insert accountability features or elements into the performed job functions. The accountability features may include quality control checks or verifications incorporated into the job function documentation. For example, the quality control check may include, but is not limited to; making sure all the information for a form has been entered before the form is submitted for further processing. In another instance, the quality control check may include asking the employee a question to confirm the information provided on the form. Further, the managed ranking may include, but is not limited to, broader and/or more detailed documentation for a job function than may be found or ranked in the initial, repeatable, and/or defined ranking levels.

In another instance, the managed ranking may also be associated with or may include job function documentation that may be integrated into the work flow in an automated manner or a non-automated manner. For example, in one instance, a portion of the job function documentation may be presented to the employee as they perform the job function. This may include instructions on what the employee should do to complete at least a portion of the job function. In another instance, the job function documentation may enable the employee to enter collected information from a patient that may be verified in an automated manner or used to complete an automated function. The automated function may include, but is not limited to, generating a cost estimate of the services that may be provided to the patient. In another instance, the automated function may be related to receiving payment for services that may be or may have been already provided to the patient.

In terms of staffing, the managed ranking may be assigned to performance criteria in which the job function may be performed by a senior staff member who may not have a defined management role. In the patient intake embodiment, the senior staff member may be a senior registrar that may not have management responsibility for less senior registrars. In this instance, the managed ranking may apply to staff members who are able to execute the job functions mostly in part with minimal training. The lower training threshold may be enabled by the job function documentation that may be included in the staff member's work flow. At this level, the staff member may not have received professional training to implement the job function. Also, the staff member may not have been certified by a third party to qualify for authorization to execute a managed ranking job function. The work flow may include a series of job functions that the staff member may complete throughout the work day or may include job functions that may be executed to complete one or more tasks related to the staff member's role and responsibilities.

In terms of cost estimate, the managed ranking may include a charge history and payer contract information for a particular good or service of the healthcare provider. The charge history may reflect what the healthcare provider may have charged for a similar good or service that may have been previously billed to the patient or another patient. The cost estimate may also include payer contract information that may indicate the cost of a third party service, item, or equipment that may have been negotiated by the insurance company of the patient. Additionally, the cost estimate may include the amount owed by the patient after the patient's benefit insurance has been applied to the cost of the provided service. For example, the cost estimate may itemize the amount owed by the patient and the amount that may be paid by the insurance company that manages the patient's benefits. In one specific embodiment, the cost estimate may include the charge history, payer contract information, patient benefit amount owed by the insurance company, and an amount owed by the patient to receive a managed ranking. In another embodiment, the cost estimate job function may include the patient benefit amount and the amount owed by the patient to receive the managed ranking.

In this embodiment, the cost estimate may be provided for a majority of services offered by the healthcare provider. In this instance, the cost estimate may include an amount for the full encounter for the projected services that may be rendered by the healthcare provider. However, the full encounter may not include cost estimates for services rendered for patient follow ups or for services that may be rendered by other medical professionals who may not be a part of the healthcare provider. For example, the cost estimate may include an amount for the inpatient or outpatient care provided by the healthcare provider, but may not include services provided by another medical provider that may provide additional care after the patient leaves the healthcare provider's facility. The additional services may include physical therapy, occupational therapy, or any other medical service that may not be provided by the healthcare provider.

In contrast to the defined ranking, the managed ranking for the cost estimate job function may be assigned when the healthcare provider has implemented the cost estimate job function across a relatively broad range of services when compared to the defined ranking.

In terms of payment job functions, the managed ranking may also apply when payment for the healthcare provider services may a majority of payment options that may be available to patients. At the very least, the payment options may include government insurance (e.g., Medicare), contracted private insurance, and/or employer benefits. The collection of a co-payment may also be done during pre-service registration or during discharge. In another embodiment, the payment job function may include instructions to determine how much the patient may be able to pay. The estimated payment determination may be based on the patient's insurance, billing history, payment history, and/or any other information that may be indication of the patient's ability to pay. In one specific embodiment, the estimated payment determination may determine a discount to incentivize the patient to pay as soon as possible and/or as much of the amount owed as possible.

In another instance, the managed ranking may also apply when a financial checklist is provided to the patient indicating their financial responsibility for the amount owed and the timing of payment(s). The timing of payments may include a standard time window applied as a default or the timing payment may include timing agreed to by the patient. In one specific embodiment, the financial checklist may include amounts and times for payment that have been negotiated with and/or approved by the patient. In the managed ranking level, the financial checklist may be manually created by a staff member. This may include entering data into a checklist that may be drawn from automated systems or electronically stored records or information. The checklist may be in written or printed form or may be provided to the patient in electronic form.

The managed ranking embodiment for payment job functions may also include estimation/payment reconciliation or quality checks. In this instance, a systematic selection of cost estimates and payment functions may be reviewed to verify compliance with documented procedures. The systematic selection may include a percentage of the cost estimates and/or payment plans (e.g., payments) made over a period of time. In another instance, the systematic selection may include reviewing a defined number of cost estimates or payment plans. The defined number may indicate that every third cost estimate or payment plan may be reviewed. The defined number may vary between any integer value that may be selected by healthcare provider.

The optimized ranking may be the level above the managed ranking and may be assigned to performance criteria that may have greater structure and organization than the managed ranking. Broadly, the optimized ranking may indicate that the job function may be performed in a way that may include more management oversight than the job functions ranked at the defined or managed level. The oversight, in one instance, may include an attempt to automate accountability features or elements into the performed job functions. A majority of job functions that are performed by the healthcare provider may include the automated features or elements. The accountability features may include quality control checks or verifications incorporated into the job function documentation. For example, the quality control check may include, but is not limited to; making sure the information for a form has been entered before the form is submitted for further processing. In another instance, the quality control check may include asking the employee a question to confirm the information provided on the form. Further, the optimized ranking may include, but is not limited to, broader and/or more detailed documentation for a job function than may be found or ranked in the initial, repeatable, defined ranking, and/or managed levels. In one specific embodiment, the optimized level may include a higher degree of automation than the lower ranking levels.

In another instance, the optimized ranking may also be associated with or may include job function documentation that may be integrated into the work flow in a fully automated manner. For example, in one instance, a portion of the job function documentation may be presented to the employee as they perform the job function. This may include instructions on what the employee should do to complete at least a portion of the job function. In another instance, the job function documentation may enable the employee to enter collected information from a patient that may be verified in an automated manner or used to complete an automated function. The automated function may include, but is not limited to, generating a cost estimate of the services that may be provided to the patient, conducting patient intake, and/or collecting payments from patients.

In terms of staffing, the optimized ranking may be assigned to performance criteria in which the job function may be performed by a staff member that may not have a defined management role or have a certain level of seniority to be authorized to perform the job function. In the patient intake embodiment, the staff member may be a registrar that may not have management responsibility for less senior registrars. In this instance, the optimized ranking may apply to staff members who are able to execute the job functions mostly in part with minimal training. The lower training threshold may be enabled by the job function documentation that may be included in the staff members work flow. At this level, the staff members may not have received professional training to implement the job function. Also, the staff members may not have been certified by a third party to qualify for authorization to execute an optimized ranking job function. The work flow may include a series of job functions that the staff members may complete throughout the work day or may include job functions that may be executed to complete one or more tasks related to the staff member's role and responsibilities. In this instance, the documentation for the job function may be fully integrated into the staff members' work flow. For example, a majority of the job functions performed by the staff members may include documentation that provides instruction or guidance on executing the job function.

In terms of cost estimate, the optimized ranking may include a charge history and payer contract information for a particular good or service of the healthcare provider. The charge history may reflect what the healthcare provider may have charged for a similar good or service that may have been previously billed to the patient or another patient. The cost estimate may also include payer contract information that may indicate the cost of a third party service, item, or equipment that may have been negotiated by the insurance company of the patient. Additionally, the cost estimate may include the amount owed by the patient after the patient's benefit insurance has been applied to the cost of the provided service. For example, the cost estimate may itemize the amount owed by the patient and the amount that may be paid by the insurance company that manages the patient's benefits. In one specific embodiment, the cost estimate may include the charge history, payer contract information, patient benefit amount owed by the insurance company, and an amount owed by the patient to receive an optimized ranking. In another embodiment, the cost estimate job function may also include the patient benefit amount and the amount owed by the patient to receive the optimized ranking.

In this embodiment, the cost estimate may be provided for a majority services offered by the healthcare provider and for services that may be provided by other healthcare providers. In this instance, the cost estimate may include an amount for the full encounter for the projected services that may be rendered by the healthcare provider. The full encounter may include cost estimates for services rendered for patient follow ups or for services that may be rendered by other medical professionals who may not be a part of the healthcare provider. For example, the cost estimate may include an amount for the inpatient or outpatient care provided by the healthcare provider and may include services provided by another medical provider that may provide additional care after the patient leaves the healthcare provider's facility. The additional services may include physical therapy, occupational therapy, or any other medical service that may not be provided by the healthcare provider.

In contrast to the defined ranking, the optimized ranking for the cost estimate job function may be assigned when the healthcare provider has implemented the cost estimate job function across a relatively broader range of services when compared to the managed ranking. In one specific embodiment, the optimized ranking may apply when the cost estimate job function may be applied to all or a super majority of departments in the healthcare provider that provide services to patients. The super majority may include an amount that may be greater than 51 percent. In one embodiment, the super majority may include two-thirds of the departments of the healthcare provider. In another embodiment, the super majority may include three-fifths of the departments of the healthcare provider.

In terms of payment job functions, the optimized ranking may also apply when payment for the healthcare provider services may include substantially all of the payment options that may be available to patients. At the very least, the payment options may include government insurance (e.g., Medicare), contracted private insurance, and/or employer benefits. The collection of a co-payment may also be done during pre-service registration or during discharge. In another embodiment, the payment job function may include instructions to determine how much the patient may be able to pay. The estimated payment determination may be based on the patient's insurance, billing history, payment history, and/or any other information that may be indication of the patient's ability to pay. In one specific embodiment, the estimated payment determination may determine a discount to incentivize the patient to pay as soon as possible and/or as much of the amount owed as possible. Within the optimized ranking, the healthcare provider may include accountability checks that determine whether staff members are successful in collecting payments at prescribed times and at prescribed amounts. The prescribed times and amounts may be included in the payment job function documentation. In this way, the healthcare provider may be able to determine which staff members are following documented procedures and which staff members are achieving or exceeding collection guidelines. The healthcare provider may use the accountability information to optimize the collection process or to improve the collection documentation to improve payment collections.

In another instance, the optimized ranking may also apply when a financial checklist is provided to the patient indicating his financial responsibility for the amount owed and the timing of payment(s). The timing of payments may include a standard time window applied as a default or the timing payment may include timing agreed to by the patient. In one specific embodiment, the financial checklist may include amounts and times for payment that have been negotiated with and/or approved by the patient. In the optimized ranking level, the financial checklist may be created by a staff member using automated tools to collect and organize the financial information. This may include entering data into a checklist that may be drawn from automated systems or electronically stored records or information. The checklist may be provided to the patient in electronic form.

The optimized ranking embodiment for payment job functions may also include estimation/payment reconciliation or quality checks. In this instance, a systematic selection of cost estimates and payment functions may be reviewed to verify compliance with documented procedures. The systematic selection may include a percentage of the cost estimates and/or payment plans (e.g., payments) made over a period of time. In another instance, the systematic selection may include reviewing at least a majority of cost estimates or payment plans. The majority may include greater than or equal to 50 percent of the cost estimates or payments plans.

The ranking scale described above is one embodiment that may be used to rank jobs functions or performance criteria for a healthcare provider. However, in other embodiments, the ranking scales may include additional ranking levels or omit one or more of the ranking levels described above. For example, one of the ranking levels may be separated into two different ranking levels that may separate the ranking criteria between the two levels instead of having a single ranking level. In another embodiment, the ranking levels may be rearrange or omit the ranking criteria from one or more of the ranking levels. Further, two or more ranking levels may be combined to form a single ranking level that may include the ranking criteria from the two or more ranking levels.

The user device 102 may include several modules that may determine or rank the performance criteria or job functions of the healthcare provider. The modules may include software, hardware, firmware components or a combination thereof to perform the ranking analysis of the healthcare provider's operations. The modules may receive information from the healthcare provider to analyze or information may be entered into memory 106 and analyzed by the modules. In one embodiment, the modules may include, but are not limited to, a process module 114, a staff module 116, a frequency module 118, a modeling module 120, an output module 122, a service line module 124, a service mix module 126, a payer mix module 128, a co-pay module 130, a deposit module 132, a physician module 134, a location module 136, a checklist module 138, a payment module 140, a quality module 142, and/or a classifying module 144.

The process module 114 may collect and analyze the documentation that the healthcare provider may use in their business operations. The documentation may include procedures, forms, or other media that may be used to direct, assist, or record information that employees or contractors may use to perform their job functions. In one embodiment, the documentation may be related to, but is not limited to, patient intake, billing, and collections for a healthcare provider. The process module 114 may determine the work flow of various staff members ranging from entry level to management level. The work flow may include one or more job functions or performance criteria related to patient intake, billing, and/or collections. The process module 114 may determine the amount and type of documentation that may be used to perform those job functions. In certain instances, the process module 114 may determine that the job function may not have any assigned documentation. The job function may be assigned as being undocumented. In another instance, when documentation is associated with a job function, the process module may determine the job function may be designated as documented. The process module 114 may also determine a degree in which the documentation covers the role of the job function. For example, does the patient intake documentation just cover patient identify information, insurance information, payment information, medical history documentation, and the like. The process module 114 may determine which documentation may be incomplete in view of expected job function responsibilities. For example, when the patient identification documentation includes name and address, the lack of a telephone number or email address may indicate that the documentation may not be complete. The expected job function for patient intake may indicate that the email address and/or telephone number may be desirable or indicative of more sophisticated documentation than documentation that may include the additional information. In this way, the ranking module 112 may use this analysis to determine which rank to assign to the process job function.

The staff module 116 may collect and analyze the staffing that may be used to implement the job functions performed by employees of the healthcare provider. The staff module 116 may determine the level or grade of employees that may be performing the job function. For example, this may include managers, professional staff members, lead staff members, senior staff members, and staff members. The managers may have direct oversight over a department in which several levels or staff members may report up to the manager. The manager may have operational and/or financial oversight of a department or organization within the healthcare provider. The professional staff members may include specialized training or certifications to perform their job functions. This may include, but is not limited to, financial accounting, medical training, and/or computer training. The lead staff member may supervise lower level staff members and/or may train and/or mentor lower level staff members. In certain instances, the lead staff members may perform certain job functions that lower level staff members may not be authorized to perform. Alternatively, the lead staff member may verify that the lower level staff members performed the job function properly. The senior staff members may include a peer group that may not have management responsibility but may include employees with training or experience that may enable them to perform job functions that lower level staff members may not be authorized to perform. The staff members may be employees that perform job functions that are broadly generic in that there are few limitations on who may perform the job functions within this peer group.

The staff module 116 may also determine which job functions may be limited to certain employees or certain levels of employees. This determination may also indicate when the job function may be limited to certain members within a peer group. This may be an indication of special training or capability of a portion of a peer group that may indicate the staff may need training or documentation that may enable the majority of the peer group to be able to perform the same or similar job functions. Accordingly, when employees within a peer group may be segregated in this way, this may be an indication of a lack of sophistication in performing the job function. For example, the documentation may not cover the job function or training has not been formalized in a way to enable the entire peer group to perform the function. The ranking module 112 may use this information to ranking the staff level that performs this function. The level of maturity or sophistication may be ranked lower when the job function is concentrated to one or a small group of employees within a peer group. Hence, a higher ranking may be assigned when the degree of concentration or compartmentalization of a job function within a peer group is lower.

The frequency module 118 may collect and analyze the frequency in which a job function may be performed by an employee of the healthcare provider. The frequency module 118 may determine the degree of sophistication in which a job function may be consistently applied by the employees. For example, when the job function is performed in all or a majority of encounters with patients, the degree of sophistication may be relatively higher than when the job function may be implemented on a case by case basis or a special basis. The ranking module 112 may use the frequency to assign a ranking level to the job function based, at least in part, on the degree of sophistication.

The modeling module 120 may collect and analyze how employees execute a job function and determine the degree of sophistication in which the job function may be modeled. In this instance, a relatively higher degree of sophistication of a job function that may include using a relatively broader source of information to implement the job function. For example, a job function that leverages several source of information in an automated manner may have a higher degree of sophistication than a healthcare provider that uses a single source of information and implements the job function in a non-automated manner. For example, a cost estimate model that may include charge history, contract, and patient's benefits may have a higher degree of sophistication than a cost estimate model that uses a generic fee schedule.

The output module 122 may collect and analyze how employees execute a job function and determine the degree of sophistication of the output of the job function. The degree of sophistication may include how much the information in output may be personalized to the patient. For example, a sample quote (e.g., cost estimate) that may include an amount that may be provided to every patient that receives the service regardless of the patients' condition (e.g., age, gender, general health condition) may have a lower degree of sophistication than a more personalized cost estimate. The degree of sophistication may be higher for a cost estimate that accounts for differences in patients' conditions, the doctor who performs the service, or the location in which the service may be provided. The ranking module 112 may rank a highly personalized output of the job function higher than a job function that generates a generic output.

The service line module 124 may collect and analyze how employees execute a job function and determine the degree of sophistication based, at least in part, on how widespread the job function may be used within the healthcare provider. The service module 124 may determine which departments may implement a job function that may be commonly used within the department. The degree of sophistication may differ based on how widespread the job function is within the healthcare provider. For example, within the cost estimate embodiment, the cost estimate job function may have a higher degree of sophistication when all or a substantial portion of the departments within the healthcare provider provide a cost estimate to a patient. The degree of sophistication may be lower when smaller amounts of departments may provide a cost estimate to a patient.

The service mix module 126 may collect and analyze how employees execute a job function and determine the degree of sophistication based, at least in part, on how broad the scope of the job function may within the healthcare provider. For example, the service mix module 126 may determine how broad or narrow a job function may apply within the healthcare provider. In the cost estimate embodiment, when the cost estimate merely includes the cost of service of one aspect of the patient experience, the degree of sophistication may be lower than a cost estimate that includes the cost of the full encounter that the patient has with the healthcare provider. For example, the less sophisticated cost estimate may just cover acute or ambulatory care. In contrast, the cost estimate that may include costs from several organizations within the healthcare provider may have a higher degree of sophistication. In one specific embodiment, the highest degree of sophistication for a cost estimate may include cost itemization estimates for a complete plan of care. The plan of care cost estimate may include the full encounter cost estimate and cost estimate for services or equipment provided by third parties that may not be directly managed by the healthcare provider. In one instance, the third party may be a medical equipment provider or a medical service provider (e.g., home health monitoring) that may not be managed directly by the healthcare provider.

The payer mix module 128 may collect and analyze how employees execute a payment job function and determine the degree of sophistication based, at least in part, on how broad the payer mix that a patient may use to pay the healthcare provider. For example, the degree of sophistication for the payer mix may be high when the healthcare provider may interface with all or a majority of payers or medical contractors used by their patients.

The co-pay module 130 may collect and analyze how employees execute a payment job function and determine the degree of sophistication based, at least in part, on how and when the healthcare provider may collect a co-payment from a patient. A low degree of sophistication may be when the healthcare provider may make no attempt to collect a co-payment when the patient is on-site at the healthcare provider. In contrast, a high degree of sophistication may be determined when the healthcare provider may collect the co-payment before the patient receives a service and/or when the patient is discharged (e.g., before the patient leaves the healthcare provider site).

The deposit module 132 may collect and analyze how employees execute a payment job function and determine the degree of sophistication based, at least in part, on how and when the healthcare provider may implement a deposit collection.

The physician module 134 may collect and analyze how employees execute a cost job function and determine the degree of sophistication based, at least in part, on how and when the healthcare provider may account for cost differences between doctors who may perform the same or similar services. In the cost estimate embodiment, the degree of sophistication may vary based on whether the healthcare provider accounts for cost differences between doctors and/or how broadly this may apply within the healthcare provider. For example, when the amount of doctors that may be used to generate the cost differences is small relative to the amount of doctors within the practice. The degree of sophistication may be lower than when all or a majority of doctors in the practice are incorporated into the cost estimates.

The location module 136 may collect and analyze how employees execute a cost job function and determine the degree of sophistication based, at least in part, on how and when the healthcare provider may account for cost differences between locations that may be operated by the healthcare provider and that may perform the same or similar services. In the cost estimate embodiment, a relatively higher degree of sophistication may be assigned to the healthcare provider that accounts for cost differences based on location. The differences may include, but are not limited to, the cost of doctors, nursing, services, taxes, medication, overhead, and/or a combination thereof. Hence, when the healthcare provider lacks or narrowly accounts for cost differences between the locations the degree of sophistication may be relatively lower.

The checklist module 138 may collect and analyze how employees execute a cost job function and determine the degree of sophistication based, at least in part, on how and when the healthcare provider may account for cost differences between locations that may be operated by the healthcare provider and that may perform the same or similar services.

The payment module 140 may collect and analyze how employees execute a financial checklist job function and determine the degree of sophistication based, at least in part, on how and when the healthcare provider may generate a patient financial checklist that provides a detailed overview of how much the patient may be charged and how and when the patient may make payments. The degree of sophistication may vary based on how broadly the financial checklist may be used within the healthcare provider and/or a level of automation that may be used to generate the financial checklist. A higher degree of sophistication may be assigned when a broad set of departments generate financial checklists and/or the process to generate the financial checklist may be substantially automated. In contrast, a lower degree of sophistication may be assigned when few departments generate a financial checklist and/or the process to generate the financial checklist may be a substantially manual operation by the staff members.

The quality module 142 may collect and analyze how the healthcare provider may execute a quality control over the job functions performed by employees and determine the degree of sophistication based, at least in part, on how often an employee's performance may be checked. In the cost estimate embodiment, the quality check may include determining the accuracy of the cost estimate. A high quality cost estimate may have the same or substantially similar value as the final amount that may be owed by the patient. A low quality cost estimate may have a large difference between the estimated cost and the actual cost. In the payment embodiment, the quality check may compare the payment procedural requirements to collect money from patients against the actual amount of money collected from the patients. This may include when or how the payment was collected in addition to the amount collected. The degree of sophistication may be based, at least in part, on how often the quality checks may be made. For example, a low degree of sophistication may be assigned when no quality checks are performed. A relatively higher degree of sophistication may be assigned when random quality checks are performed. Another higher degree of sophistication may be assigned when a defined percentage of the quality checks are performed. When all or a majority of estimates or payment plans are quality checked the degree of sophistication may assigned at a higher level than the previous examples.

The classifying module 144 may organize the rankings of the one or more job functions to determine an overall ranking of the healthcare provider. In one embodiment, the overall ranking may be based on a level (e.g., initial, repeatable, defined, managed, or optimized) in which the healthcare provider achieves at least a common ranking of each of the job functions. Accordingly, in this embodiment, all the job functions may have a minimum ranking of defined for the healthcare provider to be assigned a defined ranking.

In another embodiment, the classifying module 144 may assign the ranked job functions to bins that represent each level of ranking performed by the ranking module 112. The overall ranking may be based, at least in part, on a statistical analysis of the amount of job functions within the bins. For example, the overall ranking may be based on the distribution of the job functions within the bins. This may include, but is not limited to, mean, average, and/or standard deviation. In another embodiment, the overall ranking may be based on the bin/level that includes the most ranked job functions.

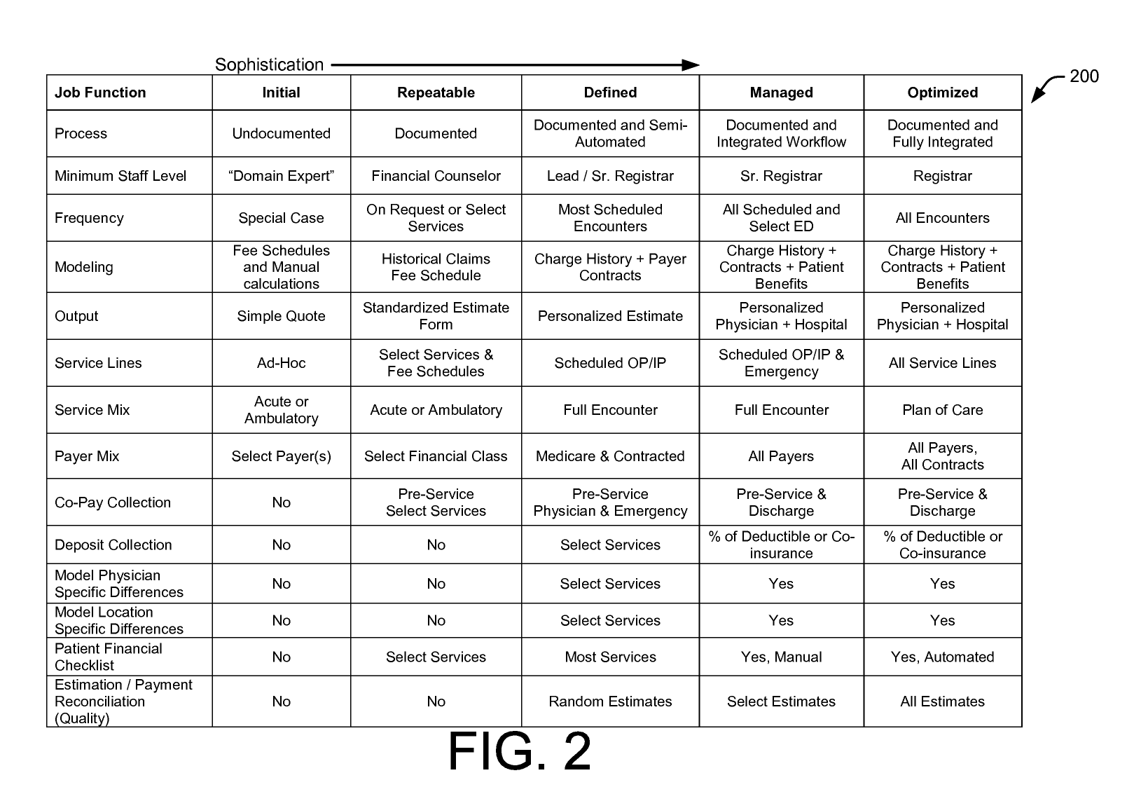

FIG. 2 illustrates a schematic table 200 illustrating one embodiment of ranking a job functions or performance criteria of a healthcare provider. The table 200 is an illustration of one embodiment based on the description of ranking levels and job functions described above in the description of FIG. 1. In other embodiments, the number and type of job functions may vary according to the configuration of the healthcare provider that may be ranked.

In this embodiment, the job function column indicates a reference to the job function or performance criteria that may be ranked by the ranking module 112. The rankings, in this embodiment, may include initial, repeatable, defined, managed, and optimized as described above in the description of FIG. 1. The job functions may include a brief explanation of how or why the job function may be ranked according to the ranking scale. The ranking criteria shown the table 200 is described above in the description of FIG. 1.

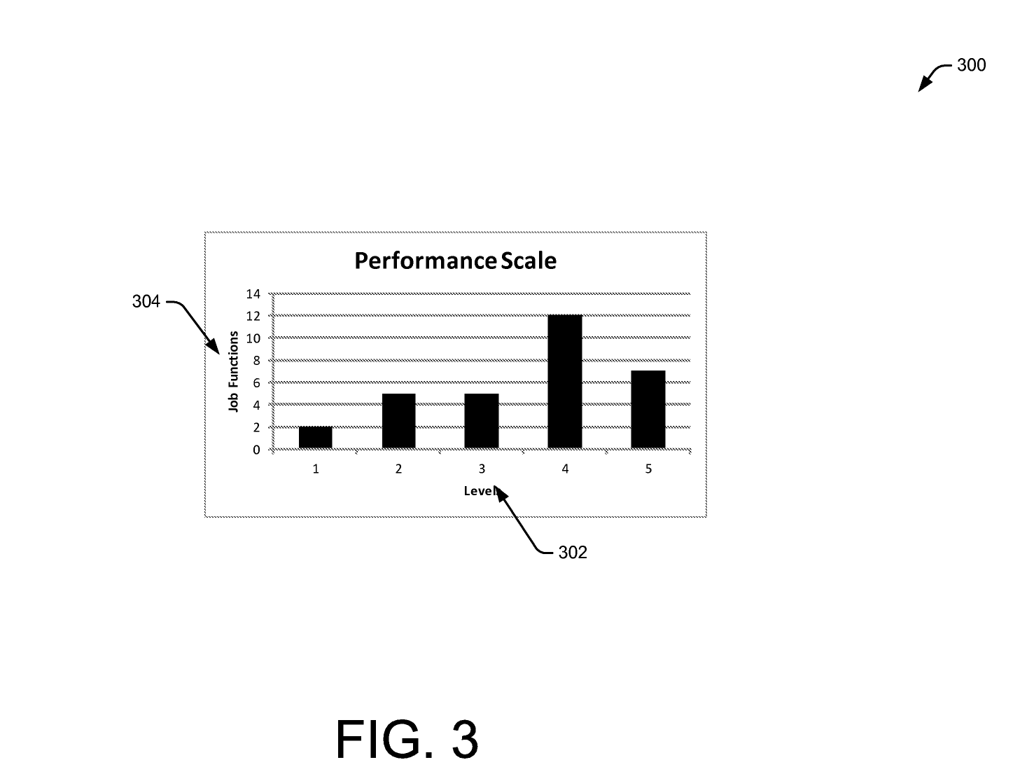

FIG. 3 illustrates one embodiment of a performance scale 300 for an overall ranking of the healthcare provider based, at least in part, on the ranking of the job functions. The performance scale may include bins 302 that represent the ranking levels (e.g., 1-5) selected by the ranking module 112. The job functions 304 may be assigned to the bins 302 based on their respective ranking. In this embodiment, level 1 (e.g., initial) may include two job functions that were ranked as initial, level 2 (e.g., repeatable) may include five job functions that were ranked at repeatable, level 3 (e.g., defined) may include five job functions that were ranked at defined, level 4 (e.g., managed) may include 12 job functions that were ranked at managed, and level 5 (e.g., optimized) may include seven job functions that were ranked at optimized.

In one embodiment, the overall ranking of the healthcare provider based, at least in part, on the performance scale 300 may be the level that includes the most or a majority of the job functions. In this instance, the overall ranking may be level 4, which may correspond to the managed ranking described above in the description of FIG. 1. In another embodiment, the overall ranking may be based on the mean or average of the distribution of job functions.

In another embodiment, the overall ranking of the healthcare provider may be broader than the previous embodiment. For example, the initial level may be the overall ranking when the healthcare provider for one or more of the following criteria: the healthcare provider may not yet adopted or implemented a strategic approach to cost estimation for medical services and/or pre-service collections across a majority of departments of the healthcare provider, the healthcare provider may not be piloting cost estimation and pre-service collection processes and tools for discrete service lines or locations, and/or performing some estimations, but they are performed exclusively by a small group of domain experts. The concept of domain experts as described above in the description of FIG. 1.

The repeatable overall ranking may be assigned to the healthcare provider based, at least in part, on one or more of the following criteria: the healthcare provider may have adopted and implemented strategic approach to cost estimation and pre-service collections and have a documented model for scheduled encounters with patients at most locations, the healthcare provider may use cost estimation models and collection calculators that incorporate both acute and professional charges, the healthcare provider may use cost estimations and collection tools to support the patient intake workflow and are available to senior staff members, and/or cost estimate may be derived from fee schedules, as well as pre-calculated and charge detail history.

The managed overall ranking may be assigned to the healthcare provider based, at least in part, on one or more of the following criteria: the healthcare provider may have adopted and implemented a strategic approach to cost estimation and pre-service collections and have a documented and integrated model for emergency room visits and scheduled encounters at all locations, the healthcare provider may use cost estimation models and collection calculators for all services and all payers that may be personalized to a patient based on their year-to-date benefits, the healthcare provider may use cost estimation and collection tools that may be integrated into a patient intake workflow and a majority of registration staff members may be accountable for their use, the healthcare provider may determine cost estimates based on fee schedules for services being offered to patients, the healthcare provider may also generate cost estimates based on variations as service location and physician-dependent service preferences.

The optimized overall ranking may be assigned to the healthcare provider based, at least in part, on one or more of the following criteria: the healthcare provider may be providing cost estimates and performing pre-service collection activities on a consistent or periodic basis with few exceptions, the healthcare provider may adopt a continuous improvement focus that may be applied to cost estimation models and collection calculators, the healthcare provider may use costs estimates that may be personalized to a patient based on their year-to-date benefits, the healthcare provider may use cost estimations and collection tools that may be integrated into the patient intake workflow and/or the registration staff members may be accountable for their use, and/or the healthcare provider may implement collections activities that incorporate a patient's propensity (ability+likelihood) to pay for the services.

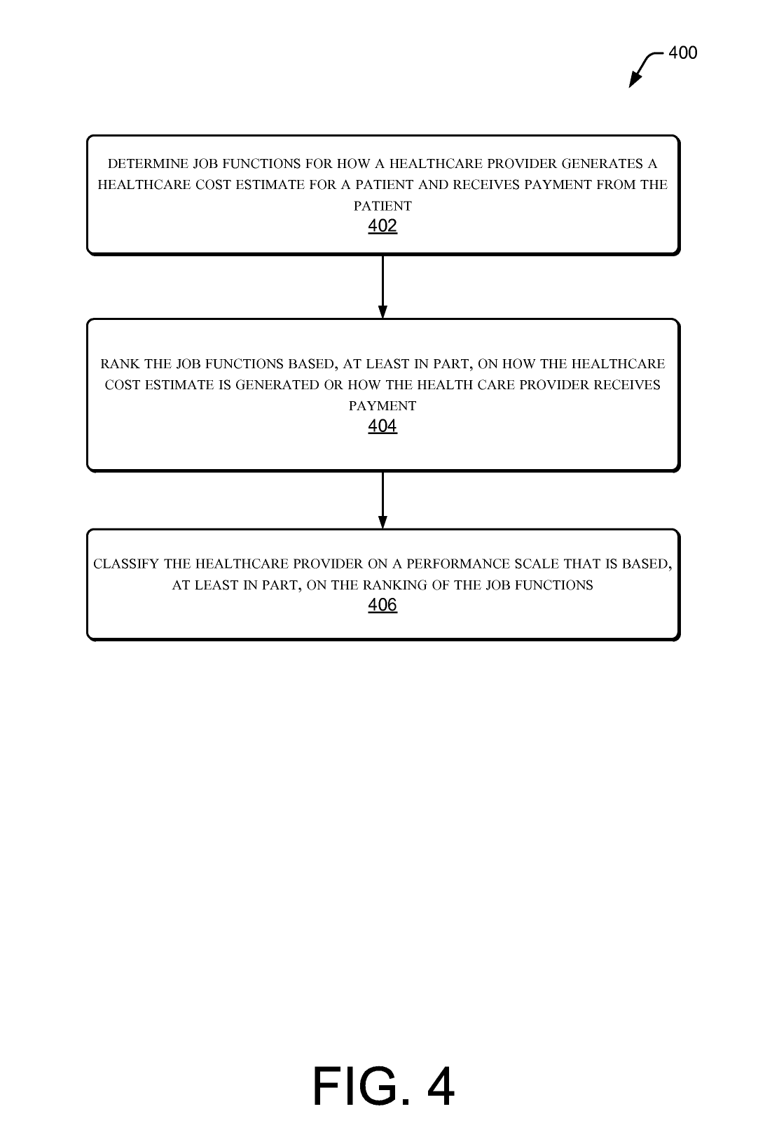

FIG. 4 illustrates a flow diagram of a method 400 for assessing the business operations of a healthcare provider. In one embodiment, the business operations may include generating a cost estimate of a patient that may receive services from the healthcare provider. The healthcare provider may also track payments received from the patient or generate a payment plan for the patient. The user device 102 may assess how the healthcare provider generates the cost estimate and/or payments and classify how sophisticated or efficient the healthcare provider may be in generating the cost estimate and/or payment. The classification may identify what the healthcare provider may need to implement to increase the sophistication or efficiency of their business operations.

At block 402, the user device 102 may determine the job functions for how a healthcare provider generates a healthcare cost estimate for a patient and receives payment from the patient. The job functions may include, but are not limited to, several aspects of the healthcare provider's business operations that range from actions taken by staff members to management decisions related to staffing, documentation, oversight, and/or cost itemization.

For example, the user device 102 may determine a process job function for generating the healthcare cost estimate. The process job function may relate to documentation used to generate or manage the generation of the cost estimate and/or payment plan. The degree of sophistication may be related to level of documentation or guidelines that may be used to generate the cost estimate and/or payment plan. For example, the user device 102 may determine whether the healthcare provider follows undocumented guidelines, documented guidelines, documented guidelines that are semi-automated, documented guidelines that are fully automated, and/or documented guidelines that are monitored for compliance. Documented guidelines may instruct or direct staff members to perform a job function in a certain way. In this embodiment, the user device 102 determines which criteria to use to distinguish a degree of sophistication of how the healthcare provider implements the process job function. This may include looking at the amount of documentation and how the documentation may be implemented within the staff members work flow. For example, semi-automated documentation may indicate a higher degree of sophistication or efficiency over a manual documentation system that may include paper. The semi-automated system may include that at least a portion of the documentation is electronic or may provide an interface for the staff member to enter or receive information. However, the staff member may still use non-electronic means (e.g., fee schedule printed on paper) to assist in generating the cost estimate. The fully automated system may indicate that a majority of the cost estimate generation documentation is provided in an electronic format that may be accessible using a computing device.

The user device 102 may also determine a staffing job function for generating the healthcare cost estimate that includes identifying the type of staff member that may generate the cost estimate and/or payment plan. In one embodiment, the staffing may include, but is not limited to: a domain expert, a financial counselor, a patient intake supervisor that supervises a portion of a patient intake process, and/or a patient intake staff member. Broadly, these staff members highlight a degree of sophistication of who may generate the cost estimate and/or payment plan.

The domain expert may be a senior employee that may be able to identify and collect information without using documentation or guidelines provided by management. The domain expert may be a “super user” that may be able to perform tasks that are restricted or unavailable to other staff members or may have knowledge of the healthcare provider's operations that may not be known or fully understood by other staff members.

A financial counselor may be a staff member that has been authorized and/or trained to manage financial concerns of the healthcare provider. This may include, but is not limited to, professional training or certification in financial, accounting, or operational matters. The financial counselor may also have an understanding of patient insurance and/or benefits. The financial counselor may also have an understanding of the accounting and cost structure of the healthcare provider. Accordingly, the financial counselor may be a senior staff member who may also direct or manage less senior staff members who may contribute to generating the cost estimate or payment plan.

The patient intake supervisor may also generate the cost estimate and/or payment plan for the patient. In this instance, the patient intake supervisor may supervise less senior staff members and may provide oversight of the patient intake process. The patient intake supervisor may have access to information or systems that may not be available to less senior staff members. Hence, the cost estimate and/or payment plan may be generated by or authorized by the senior intake supervisor.

The patient intake staff member may be an employee with minimal management responsibilities that may be directly patient facing during the patient intake process. They may collect information from the patient that may be used in the cost estimate and/or payment plan process. In this instance, the patient intake staff member may indicate a high degree of sophistication of the staffing job function. For example, the healthcare provider has been able to push the cost estimate and/or payment plan generation process to low level or junior level employees.

The user device 102 may also determine a cost calculation job function for generating the healthcare cost estimate. The cost calculation job function may indicate how the healthcare provider determines the costs that may be included in the cost estimate. The degree of sophistication of the cost calculation job function may be based, at least in part, on cost detail, automation to collect costs, and the scope of the cost estimate across and/or beyond the healthcare provider.

In one embodiment, the cost calculation job function may include, but is not limited to, generating a cost estimate using one or more of the following: fee schedules and manual calculations, fee schedules and automated calculations, historical claims, payer contracts, patient benefits, physicians assigned to provide care to the patient, and/or a hospital assigned to the patient.

The fee schedules may include general costs that may not be dependent upon the patient, doctor, or hospital. Broadly, the fee schedule may be a generic cost that may be provided to the patient that may not include considerations for additional treatment outside of a specific department within the healthcare provider. The fees schedule may be generated manually by the staff members. In another instance, the fee schedule may be automated and distributed in an electronic format.

The historical claims may be a combination of costs that other patients have been billed in the past for the same or similar services being requested by or provided to another patient. The healthcare provider may determine an estimate cost based, at least in part, on what other patients were billed in the last six or 12 months. In certain instances, the historical claims may be used to generate a cost estimate range that may be included in the cost estimate.

The payer contracts may be based on prices negotiated by a third party for services that may be rendered by healthcare provider. For example, the cost of a service may be reduced based, at least in part, on the payer contract. The healthcare provider may have a set cost for particular service, but the cost may be reduced to induce third party payers or insurance companies to enable third party's customers to use the healthcare provider.

Patient benefits may include insurance owned by the patient that they may use to further reduce the cost of healthcare services. The insurance may limit the out of pocket cost owed by the patient. In one instance, the patient may be responsible for an insurance deductible amount and the insurance company may be responsible for the remaining amount owed to the healthcare provider.

The user device 102 may determine whether the healthcare provider uses doctor specific cost itemization to account for different procedures or equipment used by doctors to treat patients. In one instance, one doctor may stipulate that a patient stay in the hospital for three days of observation following a procedure and another doctor may stipulate that a patient stay in the hospital for five days following the same or similar procedure on the patient. In this way, the cost estimate may be more personalized to the patient and may enable a more accurate cost estimate than using a fee schedule that is common for all doctors.

The cost estimate may also include cost itemization by hospital, in that different hospital may have different charges that may be based on different procedures or location (e.g., overhead). Again, differentiating costs between hospitals enables a higher degree of personalization to the patient and may lead to more accurate cost estimates.

Additional costs that may also be included in the cost estimate may include, but are not limited to: an acute care cost, an ambulatory cost, a full encounter cost for services provided by the healthcare provider, and/or a plan of care cost for services provided by the healthcare provider and a third party healthcare provider. Acute care may be related to care for a serious or chronic condition that may require inpatient care or specialized diagnostic equipment to diagnose or treat. Ambulatory care cost may be related to outpatient care for less severe illnesses. Full encounter cost may include all costs associated with services provided by the healthcare provider during treatment. This may include costs from different departments within the healthcare provider. For example, the different departments may include: emergency room, imaging, labs, general practitioner services, specialized practitioner services, and the like.

The healthcare provider may also collect payments from patients. The user device 102 may determine a co-pay collection job function that may indicate when the healthcare provider may or attempt to collect payment. For example, the patient may pay their deductible prior to receiving services or after receiving services from the healthcare provider. The co-pay collection job function may be an indication of a sophistication of the healthcare provider. For example, a more sophisticated healthcare provider may be able to accurately determine the cost of services prior to providing them than a healthcare provider who may not be able to provide a billing statement until the after the services have been provided.

The user device 102 may also determine a patient payment job function related to a payment plan or cost estimate provided to the patient. The payment plan job function may be based, at least in part, on one or more of the following: an ability of the patient to pay the healthcare provider, a billing estimate comprising a total amount owed by the patient, a billing estimate comprising an itemized amount owed by the patient, and/or a discount applied based, at least in part, on the ability of the patient to pay the healthcare provider.

At block 404, the user device 102 may rank the job functions based, at least in part, on how the healthcare cost estimate is generated. Broadly, the ranking may indicate different degrees of sophistication or efficiency in generating the cost estimate or a payment plan. The user device may determine several levels that may be used to represent varying degrees of sophistication. In one embodiment, the rankings may include an initial ranking, a repeatable ranking, a defined ranking, a managed ranking, and an optimized ranking as described above in the descriptions of FIGS. 1 and 2. The user device 102 may rank the process job function, the staffing job function, the cost calculation job function, the co-pay collection job function, and/or the payment plan job function using at least one of the ranking levels.

At block 406, the user device 102 may classify the healthcare provider on a performance scale that is based, at least in part, on the ranking of the job functions. As noted in the description of FIG. 3, the classification may be based on at least two scales. The first scale may be based on the ranking level in which the minimum ranking level of the job functions. For example, when all of the job functions are ranked at a defined level, the overall ranking of the healthcare provider may be at the defined level. However, when the job function rankings are spread across several levels the minimum level in which all job functions achieve may be the overall ranking for the healthcare provider. In another instance, the scale may be based on an average ranking based on the amount of job functions within each ranking. The lowest level job functions may have a value of one and the higher levels may have larger numbers assigned to them. The value of the job functions may be added up and divided by the amount of job functions to determine an average ranking that may be used to classify the healthcare provider.

In another embodiment, the classification may be based on certain job functions meeting or exceeding a certain ranking. In this embodiment, as described in the description of FIG. 3, the classification may be based on performing certain job functions with a certain degree of sophistication. For example, instead of using all of the job functions, the classification may focus on a portion of the job functions to determine the classification of the healthcare provider. In this way, merely determining that that healthcare provider performed to certain standards may enable the user device 102 to determine a classification of the healthcare provider.

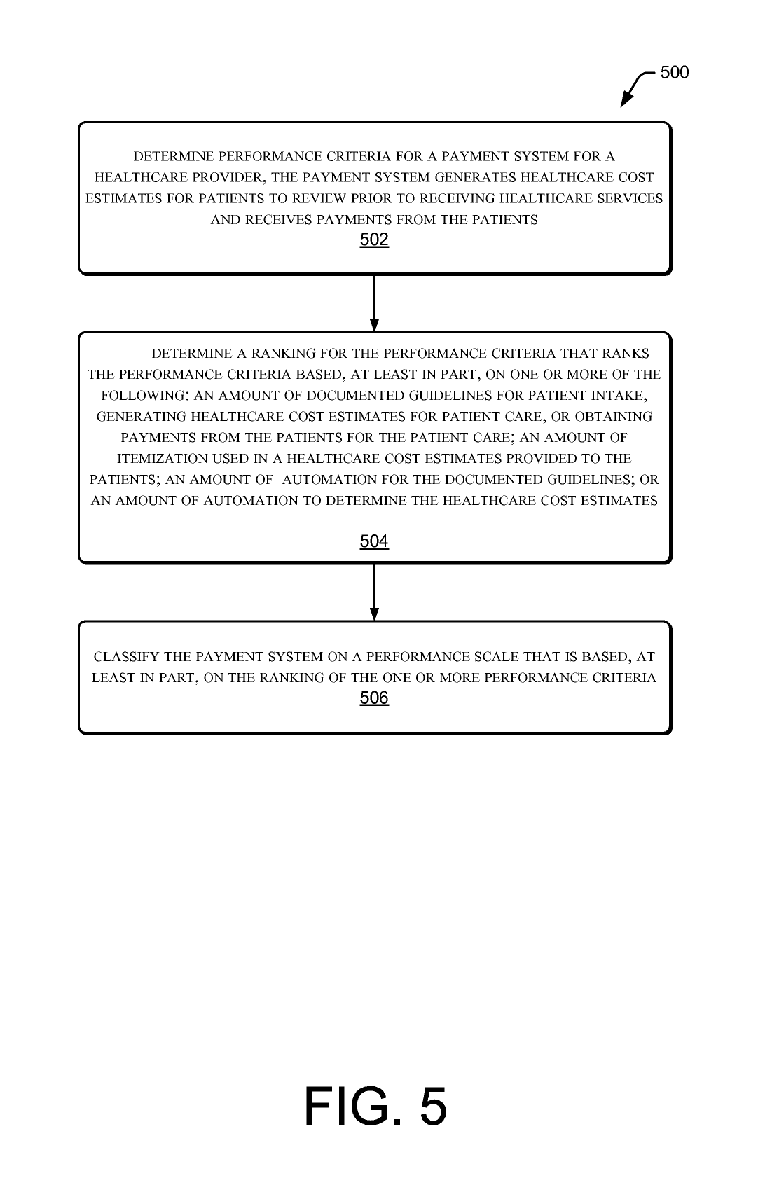

FIG. 5 illustrates a flow diagram of another method 500 for assessing the business operations of a healthcare provider. Particularly, the cost estimation and/or payment plan operations of healthcare provider. The method 500 may quantify the degree of sophistication based on threshold amounts related to performance criteria or job functions performed by the systems or employees of the healthcare provider.

At block 502, the user device 102 may determine performance criteria for a payment system for a healthcare provider. In one embodiment, the payment system may generate healthcare cost estimates for patients to review prior to the patients receiving healthcare services. The user device 102 may also receive payments from the patients for those services. The performance criteria may range from the documentation used to generate the healthcare cost estimate to billing methods used to generate the healthcare cost estimate. The performance criteria and job functions are described above in the descriptions of FIGS. 1 and 2.

At block 504, the user device 102 may determine a ranking for the performance criteria that ranks the performance criteria based, at least in part, on one or more of the following: an amount of documented guidelines for patient intake, an amount of itemization used in healthcare cost estimates, different billing schemes for doctors that perform similar services, an amount of automation for the documented guidelines, an amount of services provided by the healthcare provider that can be included in the healthcare cost estimates, an amount of staff members that are authorized to generate the healthcare cost estimates, an amount of compliance monitoring of the documented guidelines, an amount of billing differences between the healthcare cost estimates and actual healthcare costs, an amount of automation to determine the healthcare cost estimates, and/or an amount of updating to cost estimate information used to generate the healthcare cost estimates based, at least in part, on the billing amount differences between the healthcare cost estimates and the actual healthcare costs.

Broadly, the user device 102 may determine relative threshold amounts to distinguish between different degrees of sophistication of performance criteria. The threshold amounts may vary to account for changes in healthcare provider operations, insurance, and/or technology used by the healthcare provider. An administrator of the user device 102 may set the threshold amounts to reflect industry practices and/or where industry practices may intend to grow in the future. The threshold amounts may reflect different levels of efficiency or completeness of job functions that may be implemented by the healthcare provider. The threshold amounts or levels may be given names as shown in FIG. 2 (e.g., initial, repeatable, etc.) or they may be assigned letters (e.g., A, B, etc.) or numbers (e.g., 1, 2, etc.).

At block 506, the user device 102 may classify the payment system on a performance scale that is based, at least in part, on the ranking of the one or more performance criteria. In one embodiment, the user device may categorize the performance criteria into different levels of the performance scale based on the rankings of the performance criteria. The performance scale embodiments described in the description of FIG. 3 may be used to determine an overall ranking of the healthcare provider.

### CONCLUSION

Many modifications and other embodiments of the disclosure will come to mind to one skilled in the art to which this disclosure pertains and having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. One or more tangible computer readable storage media comprises computer-executable instructions that, when executed by one or more computer processors, configure the one or more computer processors to:
determining, using the one or more computer processors, job functions for how a healthcare provider generates a healthcare cost estimate for a patient and receives payment from the patient;
ranking the job functions based, at least in part, on how the healthcare cost estimate is generated or how the health care provider receives payment; and
classifying the healthcare provider on a performance scale that is based, at least in part, on the ranking of the job functions.

2. The tangible computer readable storage media of claim 1, wherein at least one of the job functions comprises a process job function and the determining the job functions further comprises:
determining the process job function for generating the healthcare cost estimate includes one or more of the following:
following undocumented guidelines;
following documented guidelines;
following documented guidelines that are semi-automated;
following documented guidelines that are fully automated; or
following documented guidelines that are monitored for compliance, and
wherein the ranking of the job functions is based, at least in part, on one or more of the determinations of the process job function.

3. The tangible computer readable storage media of claim 1, wherein at least one of the job functions comprises a staffing job function and the determining the job functions further comprises:
determining the staffing job function for generating the healthcare cost estimate includes one or more of the following staff members of the healthcare provider:
a domain expert;
a financial counselor;
a patient intake supervisor that supervises a portion of a patient intake process; or
a patient intake staff member, and
wherein the ranking for the job functions is based, at least in part, on one or more of the determinations of the staffing job function.

4. The tangible computer readable storage media of claim 1, wherein at least one of the job functions comprises a cost calculation job function and the determining the job functions further comprises:
determining the cost calculation job function for generating the healthcare cost estimate is generated based, at least in part, on one or more of the following:
fee schedules and manual calculations;
historical claims;
payer contracts;
patient benefits;
physician assigned to provide care to the patient; or
a hospital assigned to the patient, and
wherein the ranking for the job functions is based, at least in part, on one or more of the determinations of the cost calculation job function.

5. The tangible computer readable storage media of claim 1, wherein at least one of the job functions comprises a cost calculation job function and the determining the job functions further comprises:
determining the cost calculation job function for generating the healthcare cost estimate includes one or more of the following:
an acute care cost;
an ambulatory cost;
a full encounter cost for services provided by the healthcare provider; or
a plan of care cost for services provided by the healthcare provider and a third party healthcare provider, and
wherein the ranking for the performance criteria is based, at least in part, on one or more of the determinations of the cost calculation job function.

6. The tangible computer readable storage media of claim 1, wherein at least one of the job functions comprises a co-pay collection job function and the determining the job functions further comprises:
determining the co-pay collection job function occurs during one or more of the following:
when services are selected or requested by the patient;
prior to providing the services to the patient; or
after the services are provided to the patient;
wherein the ranking for the job functions is based, at least in part, on one or more of the determinations of the co-pay collection job function.

7. The tangible computer readable storage media of claim 1, wherein at least one of the job functions comprises a patient payment job function and the determining the job functions further comprises:
determining the patient payment job function based, at least in part, on one or more of the following:
an ability of the patient to pay the healthcare provider;
a billing estimate comprising a total amount owed by the patient;
a billing estimate comprising an itemized amount owed by the patient; or
a discount applied based, at least in part, on the ability of the patient to pay the healthcare provider, and
wherein the ranking of the job functions is based, at least in part, on one or more of the determinations of the payment plan job function.

8. A system comprising:
one or more memory that store computer-executable instructions;
one or more computer processors configured to access the at least one memory and execute the computer-executable instructions to:
determine, using the one or more computer processors, job functions for how a healthcare provider generates a healthcare cost estimate for a patient and receives payment from the patient;
rank the job functions based, at least in part, on how the healthcare cost estimate is generated or how the health care provider receives payment; and
classify the healthcare provider on a performance scale that is based, at least in part, on the ranking of the job functions.

9. The system of claim 8, wherein at least one of the job functions comprises a process job function and the determining the job functions further comprise computer-executable instructions to:
determine the process job function for generating the healthcare cost estimate process includes one or more of the following:
following undocumented guidelines;
following documented guidelines; or
following documented guidelines that are monitored for compliance, and
wherein the ranking of the job functions is based, at least in part, on one or more of the determinations of the process job function.

10. The system of claim 9, wherein at least one of the job functions comprises a staffing job function and the determining the job functions further comprises computer-executable instructions to:
determine the staffing job function for generating the healthcare cost estimate includes one or more of the following staff members of the healthcare provider:
a supervisor;
a senior staff member; or
a staff member, and
wherein the ranking for the job functions is based, at least in part, on one or more of the determinations of the staffing job function.

11. The system of claim 10, wherein at least one of the job functions comprises a cost calculation job function and the determining the job functions further comprises computer-executable instructions to:
determine the cost calculation job function for generating the healthcare cost estimate is generated based, at least in part, on one or more of the following:
historical claims;
patient benefits;
physician assigned to provide care to the patient; and
a hospital assigned to the patient, and
wherein the ranking for the job functions is based, at least in part, on one or more of the determinations of the cost calculation job function.

12. The system of claim 11, wherein determining job functions further comprises computer-executable instructions to:
determine the cost calculation job function for generating the healthcare cost estimate includes one or more of the following:
a full encounter cost for services provided by the healthcare provider; or
a plan of care cost for services provided by the healthcare provider and a third party healthcare provider, and
wherein the ranking for the performance criteria is based, at least in part, on one or more of the determinations of the cost calculation job function.

13. The system of claim 12, wherein at least one of the job functions comprises a co-pay collection job function and the determining the job functions further comprises computer-executable instructions to:
determine the co-pay collection job function occurs during one or more of the following:
when services are selected or requested by the patient;
prior to providing the services to the patient; or
after the services are provided to the patient;
wherein the ranking for the job functions is based, at least in part, on one or more of the determinations of the co-pay collection job function.

14. The system of claim 13, wherein determining job functions further comprises computer-executable instructions to:
determine a patient payment based, at least in part, on one or more of the following:
an ability of the patient to pay the healthcare provider;
a billing estimate comprising a total amount owed by the patient;
a billing estimate comprising an itemized amount owed by the patient; or
a discount applied based, at least in part, on the ability of the patient to pay the healthcare provider, and
wherein the ranking of the job functions is based, at least in part, on one or more of the determinations of the payment plan.

15. One or more tangible computer readable storage media comprises computer-executable instructions that, when executed by one or more processors, configure the one or more processors to:
determining, using the one or more computer processors, performance criteria for a payment system for a healthcare provider, the payment system generates healthcare cost estimates for patients to review prior to receiving healthcare services and receives payments from the patients;
determining a ranking for the performance criteria that ranks the performance criteria based, at least in part, on one or more of the following:
an amount of documented guidelines for patient intake, generating healthcare cost estimates for patient care, or obtaining payments from the patients for the patient care;
an amount of itemization used in a healthcare cost estimates provided to the patients;
an amount of automation for the documented guidelines; or
an amount of automation to determine the healthcare cost estimates;
classifying the payment system on a performance scale that is based, at least in part, on the ranking of the one or more performance criteria.

16. The tangible computer readable storage media of claim 15, wherein the performance criteria is further based, at least in part, on one or more of the following:
an amount of services provided by the healthcare provider that can be included in the healthcare cost estimates;
an amount of staff members that are authorized to generate the healthcare cost estimates;
a frequency of when the documented guidelines are updated; or
an amount of compliance monitoring of the documented guidelines.

17. The tangible computer readable storage media of claim 15, wherein the amount of itemization is based, at least in part, on one or more of the following:
different billing schemes for doctors that perform similar services; or
different billing schemes for healthcare locations that offer similar services.

18. The tangible computer readable storage media of claim 15, wherein the performance criteria is further based, at least in part, on billing amount differences between the healthcare cost estimates and actual healthcare costs.

19. The tangible computer readable storage media of claim 18, wherein the performance criteria is further based, at least in part, on an amount of updating to cost estimate information used to generate the healthcare cost estimates based, at least in part, on the billing amount differences between the healthcare cost estimates and the actual healthcare costs.

20. The tangible computer readable storage media of claim 15, wherein the classifying of the payment system comprising:
categorizing the performance criteria into different levels of the performance scale based on the rankings of the performance criteria; and
determining a rating of the payment system based, at least in part, on an amount of performance criteria categorized into the different levels of the performance scale.
